(19) United States
(12) Patent Application Publication
(10) Pub. No.: US 2026/0057443 A1
(43) Pub. Date: Feb. 26, 2026

(54) SYSTEM AND METHOD FOR THE OPTIMIZATION OF INVESTMENT PORTFOLIO BASED ON INVESTOR PREFERENCES AND PERSONALITY

(71) Applicant: Amir AYAL, Herzelia (IL)

(72) Inventor: Amir AYAL, Herzelia (IL)

(21) Appl. No.: 18/812,958

(22) Filed: Aug. 22, 2024

(51) Int. Cl. G06Q 40/06; G06F 16/25; G06Q 30/0201

(52) U.S. Cl. CPC G06Q 40/06; G06Q 30/0201; G06F 16/254

(57) ABSTRACT

A system for recommending investments to an investor, the system comprising one or more memory devices; and one or more processing devices operatively coupled to the one or more memory devices, wherein the one or more processing devices are configured to create an asset database from which personalized investment portfolios can be continuously constructed.

### FIELD OF INVENTION

The present disclosure relates to automated computerized investment systems, and more specifically to a system and method for generating investment portfolios based on personalized investor preferences and behavior.

### BACKGROUND OF INVENTION

Irrational behavior of investors has caused massive damages to the global economy over the years. Human nature is built around the basic “fight-or-flight” instincts, and that effects a lot of investments specifically, as well as world economics generally. Most of the world's developed population has some form of investment, whether by choice or by law (pensions, 401K, etc.). However, each investor is different in his risk tolerances based on his own personality. Many times, a person may make bad decisions regarding his investments and savings plans because he assumes risk that might not be there—a simple newspaper article may promote a ‘fight-or-flight’ reaction that will cause a specific investor to make a decision based on irrationality rather than intelligence.

Many books were written, and much research made on the irrationality of human behavior when it comes to the finance system and the investment market. For example Irrational Behaviour of Investors: Evidences from International Literature Review, SSRN electronic journal, Sarika Srivastava et al. describes a plethora of research done in the field of finance based behavioral science—including phenomenon like ‘fear of missing out’ (hereinafter—FOMO), impulsive mental activity that make people herd when someone else they know (or heard of) invested in something, they must invest in it too. Wanting to buy current winner stock and sell current losers, based on emotional investors requests, when financially it would have been smarter and more profitable to buy recent winner stock and recent loser stock, etc.

Genetics makes people act emotionally much faster than they do rationally, which is the cause of a lot of bad decision making in many fields, and this can be seen in much irrational behavioral research done in the field, e.g. Dan Ariely's many articles and researches done in MIT. This makes us as people often act out of pure emotion, which is different in every one of us, instead than with rational thought that has a good potential of stabilizing the market and ensuring better financial results for all of us. In view of the above, there is still an unmet long-felt need a system and a method that provides a synchronization between investment portfolios to investors behavioral profiles, in order to reduce emotion-based responses from investors.

### SUMMARY OF THE PRESENT INVENTION

It is an object of the present invention to disclose a system for recommending investments to an investor the system comprising
one or more memory devices; and
one or more processing devices operatively coupled to the one or more memory devices, wherein the one or more processing devices are configured to create an asset database from which personalized investment portfolios can be continuously constructed by first steps of Asset Data preparation comprising
   (i) inputting predefined financial asset information or data into an electronic database controlled by a database management system (DBMS)
   (ii) preprocessing said financial assets by analyzing said asset with analyzing tools said analyzing tools selected from the group consisting of SHARPE, SKEW, Implied Volatility, CALMAR, OMEGA, SORTINO RATIO TREYNOR RATIO, VIX
   (iii) second steps of Asset Data preparation comprising
   (iv) defining a first tag and annotation of each asset with asset analysis data obtained from same
   (v) further combining said first tag and first annotated analysis results from a plurality of said analyzing means to define a second tagged and annotated definition of said same financial asset
   (vi) updating said database periodically or continuously to provide sets of tagged and annotated financial assets and steps of investor data preparation comprising Investor Data preparation having steps of
   (vii) creating an investor profile database comprising multiple sourced investor data and information from the group consisting of direct, indirect, implicit and explicit sources
   (viii) sending said investor data and information through an Extract Transform Load layer for combining said investor data and information and/or from multiple sources into an Investor Information database said processing devices further configured for updating continuously or periodically said investor data comprising circumstantial investor information concerning said any personal information, age, health status, dependents, personality traits, work history, credit score, hobbies, socio-economic status, financial history and/or receiving behavioural investor information concerning said investor comprising phone call frequency, social media participation, FOMO score, financial website accessing frequency, evidence of alteration in emotional status and interpreting potential for said information to influence the risk aversion score and defined target rate of return score of said investor
   (ix) recommending said investments to said investors by an ML training model with defined hyper parameters.
It is a further object of the present invention to disclose the aforementioned wherein said ML training model is selected from the group consisting of Collaborative Filtering, Content-Based Filtering, Hybrid Models, Recurrent Neural Networks (RNNs) or Long Short-Term Memory (LSTM), Factorization Machines.
It is a further object of the present invention to disclose the aforementioned wherein said model training is by gradient descent or alternating least squares, sourcing libraries such as TensorFlow, PyTorch, or scikit-learn.
It is a further object of the present invention to disclose the aforementioned wherein said ML model is evaluated by steps of splitting datasets into training and testing datasets, running said ML model, recording performance metrics comprising precision, recall, or mean average precision and assessing model with new data, fine tuning hyperparameters by random search or grid search to optimize performance
It is a further object of the present invention to disclose an automated computer implemented method for providing an asset database from which personalized investment portfolios can be continuously constructed comprising steps of
(x) inputting predefined financial asset information or data into an electronic database controlled by a database management system (DBMS)
(xi) preprocessing said financial assets by analyzing said asset with analyzing tools
(xii) defining a first tag and annotation of each asset with asset analysis data obtained from same
(xiii) further combining said first tag and first annotated analysis results from a plurality of said analyzing means to define a second tagged and annotated definition of said same financial asset
(xiv) updating said database periodically or continuously to provide sets of tagged and annotated financial assets.
It is a further object of the present invention to disclose the aforementioned method of wherein said analyzing tools are selected from the group consisting of SHARPE, SkEW, Implied Volatility, CALMAR, OMEGA, SORTINO RATIO TREYNOR RATIO.
It is a further object of the present invention to disclose an automated computer implemented method for inferring or predicting investor preference within a plurality of financial assets said method comprising steps of
(xv) collecting multiple sourced investor data from the group consisting of direct, indirect, implicit and explicit sources
(xvi) sending said investor data through an Extract Transform Load layer for combining said investor data from multiple sources into an Investor Information database.
It is a further object of the present invention to disclose the aforementioned method wherein said investor data comprises any personal information, age, health status, dependents, personality traits, work history, credit score, hobbies, socio economic status, financial history.
It is a further object of the present invention to disclose the aforementioned method wherein said method comprises updating continuously or periodically said investor data.
It is a further object of the present invention to disclose the aforementioned method wherein said method comprises steps of receiving circumstantial investor information concerning said any personal information, age, health status, dependents, personality traits, work history, credit score, hobbies, socio-economic status, financial history and interpreting potential for said information to influence the risk aversion score of said investor.

It is a further object of the present invention to disclose the aforementioned method wherein said method comprises steps of receiving behavioural investor information concerning said investor comprising phone call frequency, social media participation, FOMO score, financial website accessing frequency, evidence of alteration in emotional status and interpreting potential for said information to influence the risk aversion score of said investor.

It is a further object of the present invention to disclose a decision support method comprising:
receiving, by a processor, a report indicating a user-reported investor decision to acquire an asset including user's expected probability of a defined outcome threshold
estimating by a processor said user's extent of implementation of prospect theory to said user's expected probability of a defined outcome threshold
calculating expected probability of a defined outcome threshold of a series of Assets within an Asset Db by the method of Asset Data preparation comprising
   (xvii) inputting predefined financial asset information or data into an electronic database controlled by a database management system (DBMS)
   (xviii) preprocessing said financial assets by analyzing said asset with analyzing tools said analyzing tools selected from the group consisting of SHARPE, SKEW, Implied Volatility, CALMAR, OMEGA, SORTINO RATIO TREYNOR RATIO, VIX
   (xix) a second step of Asset Data preparation comprising
   (xx) defining a first tag and annotation of each asset with asset analysis data obtained from same
   (xxi) further combining said first tag and first annotated analysis results from a plurality of said analyzing means to define a second tagged and annotated definition of said same financial asset
      (xxii) calculating expected probability of a defined outcome threshold of said assets
      (xxiii) comparing probability of said defined outcome with user's expected probability of a defined outcome threshold and recommending to said user any asset or assets with a higher probability of a defined outcome wherein said outcome is equal to or higher than said user's expected probability of said defined outcome threshold.
   It is a further object of the present invention to disclose the aforementioned method of claim 12 wherein said recommending is based on selecting from an asset Db containing assets with different probabilities of gaining a predetermined yield within a predefined time and probabilities of losses within a predefined time.

### BRIEF DESCRIPTION OF THE FIGURES

The accompanying drawings, which are included to provide a further understanding of the invention and are incorporated in and constitute a part of this specification, illustrate embodiments of the invention and together with the description serve to explain the principles of the invention.

FIG. 1 depicting a top-down description of the investment portfolio suggestion system.

FIG. 2 depicting a flow chart for collecting and storing investor information.

FIG. 3 depicting a flow chart for analyzing investment assets and storing them.

FIG. 4 depicting a flow chart for the training of a machine learning model for creating of investment portfolios for a specific investor.

FIG. 5 depicting the flow the system's interaction with an investor over investor profile changes.

FIG. 6 illustrating modules of the system.

FIG. 7 illustrating that an investor profile may be built using AI and machine learning,

FIG. 8 depicts modules of an aspect of the invention.

FIG. 9 showing steps of the decision support method of the present invention.

FIG. 10 is a graph depicting loss aversion.

FIG. 11 is a graph depicting Value at Risk (VaR)

### DETAILED DESCRIPTION OF PREFERRED EMBODIMENTS

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide a decision support system and methods to help individual investors mitigate deleterious effects on their investments by behavior commonly described as prospect theory when making investment decisions which may prevent maximizing utility of these decisions based on the probability of outcomes.

The present invention herein described provides system and method for recommending investments to an investor. A crucial added value is that Artificial Intelligence (AI) techniques enable the system to self-study through accumulated data both on the potential investment assets (stocks, bonds, real estate) and the investor's behavior (risk tolerance, decision making).

Prospect Theory describes common behaviours of people when given choices which involve probability. It assumes that individuals make decisions based on expectations of loss or gain from their current relative position.

Characteristics of Prospect Theory include the following: An important element of prospect theory is the idea that individuals are particularly averse to losing what they already have and less concerned to gain. Given a choice of equal probability, individuals would choose to preserve their existing wealth, rather than risk the chance to increase wealth.

Prospect theory can explain why people exhibit both risk-seeking and risk-averse behaviour.

The first instance of this theory was proposed by Daniel Kahneman and Amos Tversky in “Prospect Theory: An Analysis of Decision under Risk” (1979)

### Features of Prospect Theory

Prospect theory places emphasis on how individuals frame situations and outcomes in their mind. Individuals may use rules of thumbs and the status quo bias.
Certainty effect: People give greater weighting to certainty than outcomes that are merely probable.
Reflective effect. In terms of positive gains, people give greater weighting to a small certain gain over a probable larger gain. But, in terms of negative gains, people exhibit risk-seeking behaviour-people preferring a loss that is probable over a small loss that is certain. (this seems to contradict the desire for insurance, but it is for moderate losses, rather than catastrophic losses.)

### Model

In the editing phase, people decide which outcomes they consider equivalent, set reference points, simplification and combining probabilities.

In the evaluation phase, people compute utility based on the probability of certain outcomes, then choose alternatives with higher utility.

Prospect Theory Differs from Expected Utility Theory

Expected Utility theory assumes individuals will choose the outcome which gives maximum utility given the probability of outcomes.

Prospect theory allows for the fact that individuals may choose a decision which doesn't necessarily maximise utility because they place other considerations above utility.

Myopic loss aversion (MLA) stems from prospect theory. MLA refers to the propensity for people to focus on short-term losses and gains and to weigh them more heavily than long-term losses and gains. This bias causes people to make worse decisions due to the prioritization of avoiding immediate losses instead of achieving long-term gains.

A prolific study that examined myopic loss aversion was conducted by Gneezy and Potters in 1997. [8] In this study, participants were asked to play a simple betting game in which they could either bet on a coin landing on heads or tails, or they could choose to not bet at all. The participants were provided with a particular amount of money to commence the experiment with, and told to maximize their earnings over a series of rounds.

The results of the study exhibited that participants were more likely to place a bet when they had just lost money in the previous round, and they were more likely to avoid a bet when they had just won money in the previous round. This behavior is consistent with myopic loss aversion theory, as the participants were placing greater magnitude on their short-term gains and losses instead of their overall earnings over the course of the study.

In addition, the study found that participants that were provided with a higher amount of money at the beginning of the study tended to be more risk-averse than those who were given a lower starting amount. This result is consistent with the diminishing sensitivity to changes in wealth predicted by prospect theory.

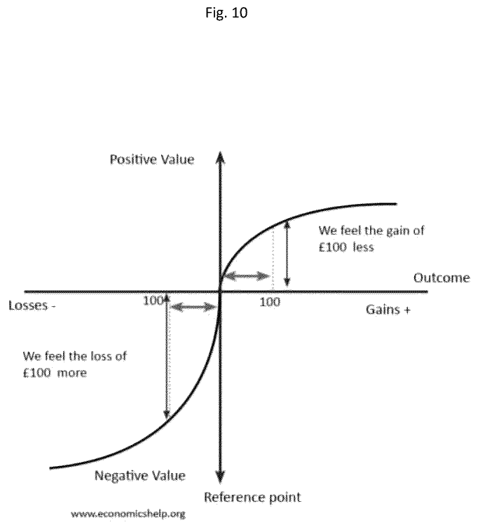

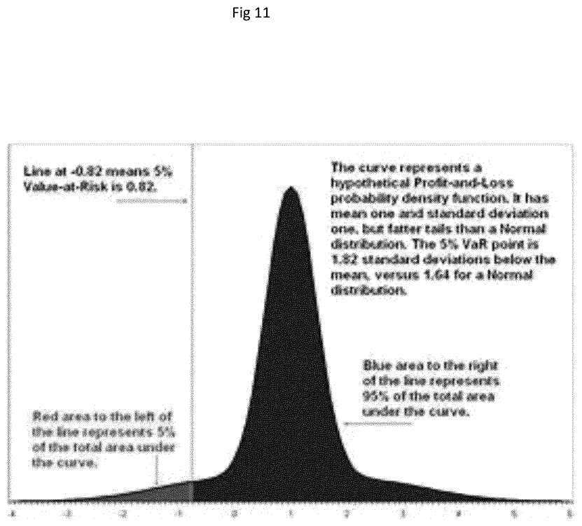

Overall, the study by Gneezy and Potters gives light to the existence of myopic loss aversion, and it specifically exhibits how this bias can result in people making poorer decisions. By analysing how prospect theory and myopic loss aversion influence decision-making, it provides the ability for researchers and policymakers to create interventions that help people make more informed choices and attain their long-term goals. FIG. 10 us a graph depicting loss aversion. The value function that passes through the reference point is s-shaped and asymmetrical. The value function is steeper for losses than gains indicating that losses outweigh gains.

The disposition effect is an anomaly discovered in behavioral finance. It relates to the tendency of investors to sell assets that have increased in value, while keeping assets that have dropped in value

One effective technique for mitigating the negative effects of impulsive, irrational decision making, in the context of stock market investing, is implementing a deliberate decision-making framework such as “Implement a Cooling-Off Period.”

### Example

1. Establish a Cooling-Off Period: Before making any significant investment decisions, set a predetermined period of time during which the investor refrains from acting impulsively. This could be a day, a week, or even longer depending on the urgency of the decision.
2. Use System 2 Thinking: During this cooling-off period, according to Kahneman, the investor should engage System 2 thinking, which is slower, more deliberate, and analytical. The investor should take the time to thoroughly research the investment opportunity, consider various factors such as market trends, company fundamentals, and potential risks.
3. Seek Diverse Perspectives: the investor should consult with trusted mentors, financial advisors, or knowledgeable peers to gain diverse perspectives on the investment opportunity. This helps uncover blind spots and biases that might have been overlooked in the investor's initial assessment.
4. Create Decision Criteria: Clear criteria for evaluating investment opportunities, such as risk tolerance, return expectations, and investment horizon should be established. This helps ensure that decisions are guided by rational parameters rather than emotional impulses.
5. Simulate the Outcome: Use financial modeling or simulation tools to simulate the potential outcomes of your investment decisions under different scenarios. This can provide valuable insights into the expected returns and potential risks associated with the investment.
6. Reflect and Reevaluate: Take the time to reflect on the decision-making process during the cooling-off period. Consider whether initial instincts were driven by emotion or rational analysis. Reevaluate investment thesis in light of new information or insights gained during the deliberation period.
7. Implement Risk Management Strategies: Develop a risk management plan to mitigate potential losses and protect the investment portfolio against market volatility. This could include diversification, stop-loss orders, or hedging strategies.

By implementing a cooling-off period and engaging System 2 thinking, one can mitigate the negative effects of fast thinking and make more informed investment decisions in the stock market.

Not all investors have the knowledge or temperament or resources to manually going through the System 2 thinking steps as suggested above, and so a system and methods have been herein developed to automate, improve and scale up the process.

The core of the invention is to implement by computerized means and methods, a method to mitigate the consequences of irrational prospect theory investing. This is done by providing a buffered decision support system driven by a recommendation engine which recommends to the user investable assets valued by technical analysis of the asset based on expected utility to the user of the asset.

### Some Definitions

As used herein after, the term “FOMO” refers to any fear of missing out, a psychological term for anxiety by investors who fear on missing out on profits.

The term “ETL” refers to an Extract, Transform, Load layer for combining data from multiple systems and sources into a single database.

The term “Sharpe” refers to Sharpe ratio (index, measure, etc.) measuring the performance of a specific investment.

The term “IV” refers to instrumental variable's estimation in statistics.

The term “SKEW” refers to the measure of asymmetry of the probability distribution of a real valued random variable, in probability theory and statistics.

It is herein referenced that, where probability estimates and predictions are implemented by the present system and method, XGBoost is used herein as a machine learning algorithm for gradient boosting and is used for predictive modeling and ranking tasks.

PCT application No. PCT/EP2018/072293 system for automated investment advice and execution. This application continuously updated a list of possible investment assets, analyzing said assets. Each investor received a questionnaire to profile their risk aversity. The system than optimizes an investment portfolio for each investor.

U.S. Pat. No. 7,574,399 Hedging exchange traded mutual funds or other portfolio basket products describes a system that checks investment portfolios and hedging the involved risk. Unlike the current inventio, this patent does not involve identifying investors' profiles and attaching specific portfolios based on a specific investor profile.

U.S. Pat. No. 7,143,061 method for maintaining an absolute risk level for an investment portfolio describes a system that checks investment portfolios risk factors. This patent, like the one mentioned above, does not contain the system that identifies investors' profiles and matching investment portfolios and risk factors with individual investors.

U.S. Pat. No. 7,249,080 investment advice systems and methods describes a system that gives a investor the ability to receive advice from one or more specific advisors. The investor can then decide whether to invest in assets that have consensus, or otherwise. This patent is different from the current invention that digitally creates a investor profile and digitally matches a specific recommended investment portfolio based on both the investor profile and the asset compatibility.

It should be noted that the software application (the “system”) and the process it follows (the “method”) of the invention herein described are implemented using the Python programming language, the system and method or parts thereof, herein described could be implemented using other programming languages such as Java, C++, C#(C Sharp), JavaScript, Ruby, Go (Golang), Rust (used in systems programming and projects where security is critical), Swift, (for iOS, macOS, and watchOS app development safety and performance), Kotlin, (runs on the Java Virtual Machine (JVM) and is interoperable with Java Popular for Android app development) and others. It is further referenced that the system and methods of the present invention makes extensive use of algorithms and techniques that allow the software to learn from data and make intelligent decisions.

Specifically, the software incorporates at least two AI techniques:

Deep Forest: This is a machine learning framework that combines decision trees to create a powerful ensemble model. It is used herein classification and regression tasks.

XGBoost is used herein as a machine learning algorithm for gradient boosting (see below) and is used for predictive modeling and ranking tasks.

Gradient Boosting is a machine learning technique that combines multiple weak prediction models to form a single, more accurate prediction model1. These weak models are typically simple decision trees1. The algorithm works by building these models sequentially, with each new model trying to correct the errors made by the previous ones1. This process is iterative and allows the optimization of an arbitrary differentiable loss function1.

In the context of a software platform for recommending investments, gradient boosting can be used to predict future investment trends based on historical data.

In embodiments of the invention the method of using historical data is in stages:

Data Collection of historical data about various investments. (factors like past performance, economic indicators, market trends, etc).

Feature Engineering: Transforming the raw data into a format that can be used by the gradient boosting algorithm. (normalizing values, handling missing data, creating new features, etc).

Model Training: The gradient boosting algorithm is then trained on this data. During training, the algorithm learns how different factors affect investment performance by trying to minimize the difference (or ‘gradient’) between its predictions and the actual outcomes.

Prediction: Once the model is trained, it can be used to predict future investment performance based on current data. These predictions can then be used to recommend investments.

Model Updating: As new data becomes available, the model can be updated or ‘boosted’ to improve its predictions.

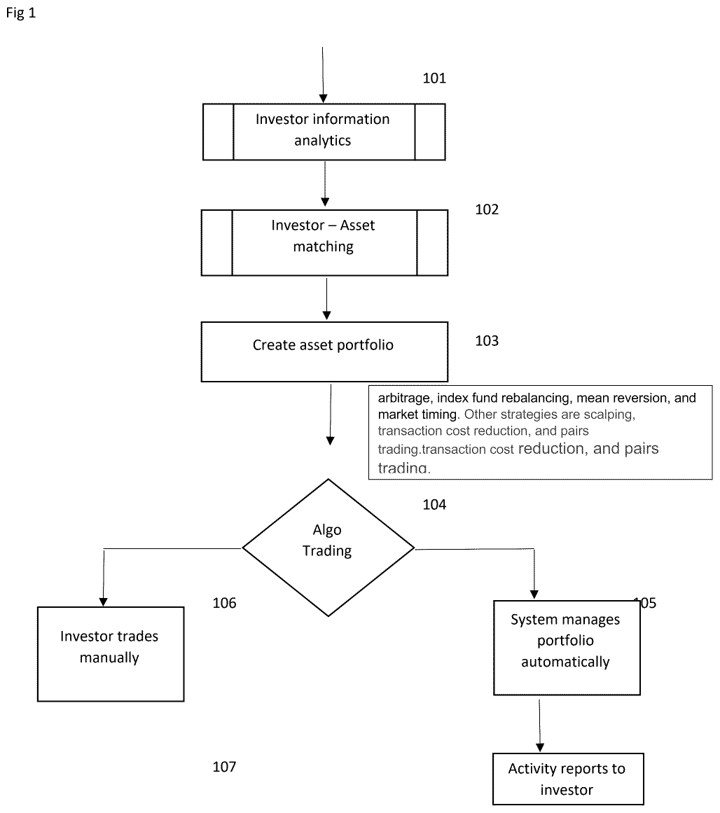

FIG. 1 depicts a basic workflow of the entire system, where an investor request is sent for creating an investment portfolio (100). The system performs investor information analytics (101) to determine the needs and desires and financial capabilities of the investor. The system then matches the investor with assets confirming to his personality, goals, etc. (102), and a suggested investment portfolio is created for the investor (103). The steps of creating the investment portfolio may include arbitrage, index fund rebalancing, mean reversion, and market timing. Other strategies that may be implemented may include; scalping, transaction cost reduction, and pairs trading, transaction cost reduction, and pairs trading.

If the investor chooses to invest (104) manually, he can do so (105), otherwise the investor can choose to let an algo-trading module run his investments (106), and he will receive regular updates from the system regarding his investments (107).

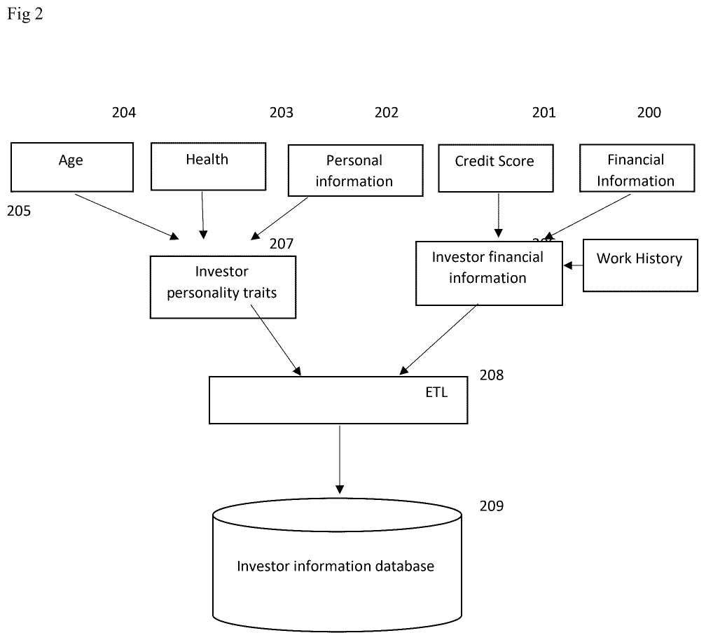

FIG. 2 describes a method of collecting investor data into a single database, to be used by a machine learning model to create a investor scoring system for potential investments. The investor's personal information (202), age (200), and health status (201) are all collected as the investor's personality traits (206). The investor's work history (205), credit score (203) and financial information (204) are all saved as the investor's financial information (207). The data is sent through an ETL layer (208) to be saved in a user profiles database (209). The user profile can be monitored and updated continuously for any change of life circumstances.

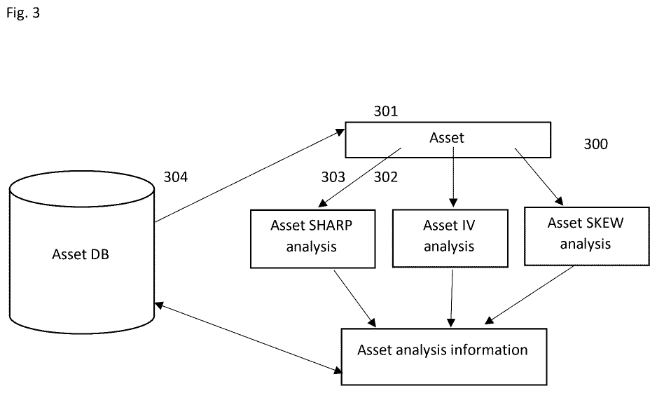

FIG. 3 depicts a system for performing analysis on assets, each asset (301) comes from an asset database (300). Each asset undergoes several analyses—these being SKEW analysis (304), SHARP analysis (302) and IV analysis (303). These are combined as asset analysis data (305), which is stored in the asset database (300). Monte Carlo simulation and analysis may also be employed at this stage, using random sampling to create thousands of simulated outcomes of implementing the system.

```
# Pseudocode for Investment Recommendation System
# Step 1: Receive user report containing investment decision
def receive_user_report( ):
  user_report = get_user_report( ) # Assume this function retrieves the
user's report
  return user_report
# Step 2: Estimate prospect theory dependence of user decision
def estimate_prospect_theory_dependence(user_report):
  # Implement prospect theory analysis (details not shown)
  prospect_theory_score = analyze_prospect_theory(user_report)
  return prospect_theory_score
# Step 3: Inspect Asset Database for yield probabilities (technical
analysis)
def inspect_asset_db(asset_database):
  best_asset = None
  max_yield = 0.0
  for asset in asset_database:
    yield_probability = calculate_yield_probability(asset) # Technical
analysis
    if yield_probability > max_yield:
      max_yield = yield_probability
      best_asset = asset
  return best_asset
# Step 4: Value at Risk (VaR) assessment
def calculate_var(asset) :
  # Assume VaR calculation based on historical data and confidence level
  var_value = calculate_var_for_asset(asset)
  return var_value
# Step 5: Monte Carlo simulation for asset outcomes
def monte_carlo_simulation(asset):
  num_simulations = 1000 # Number of simulations
  simulated_returns = [ ]
  for _ in range(num_simulations):
    # Simulate random input values (e.g., market volatility)
    input_values = generate_random_inputs( )
    # Calculate outcome (e.g., investment return) based on inputs
    outcome = simulate_asset_performance(asset, input_values)
    simulated_returns.append(outcome)
  return simulated_returns
# Main recommendation process
def recommend_investment( ):
  user_report = receive_user_report( )
  prospect_theory_score =
estimate_prospect_theory_dependence(user_report)
  asset_database = load_asset_database( )
  best_asset = inspect_asset_db(asset database)
  var_value = calculate_var(best_asset)
  simulated_returns = monte_carlo_simulation(best_asset)
  return best_asset, var_value, simulated_returns
# Example usage:
best_asset_choice, var_estimate, simulated_results =
recommend_investment( )
print(f“Recommended asset: {best_asset_choice}”)
print(f“Estimated VaR: {var_estimate}”)
print(f“Simulated returns: {simulated_results}”)
```

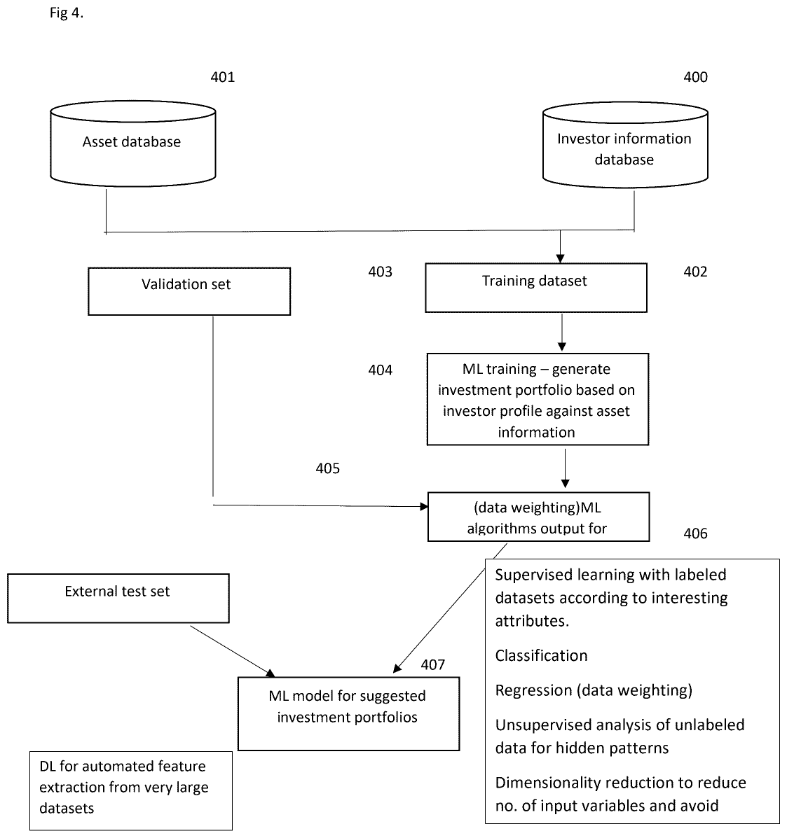

FIG. 4 shows a training method of a machine learning model that combines data from an investor information database (401) and the asset database (400). From these a training dataset is prepared (403) and sent to a machine learning module to determine algorithms for combining investor's needs with the appropriate assets to invest in (404). The machine learning module outputs a base algorithm for preparing an investment portfolio for a investor (405). This algorithm is checked against a validation dataset (402). This produces a final version of algorithms for creating suggested portfolios (407), which is tested against an external dataset (406).

The external data set (406) comprises (data weighting) ML algorithms output for Supervised learning with labeled datasets according to interesting attributes. Tasks include:

Classification (Deep Forest machine learning framework is used).

Regression (data weighting) (Deep Forest machine learning framework is used) Unsupervised analysis of unlabeled data for hidden patterns.

Dimensionality reduction to reduce no. of input variables and avoid redundancy of parameters.

The steps of the training method described above are herein provided as a pseudocode giving high level view of the process:

This pseudocode provides a high-level overview of the process described in FIG. 4.

# Pseudocode
# Load data from investor information database and asset database
investor_data = load_investor_data( )
asset_data = load_asset_data( )
# Prepare training dataset
training_data = prepare_training_data(investor_data, asset_data)
# Train machine learning model
base_algorithm = train_ml_model(training_data)
# Validate the base algorithm with a validation dataset
validation_data = load_validation_data( )
final_algorithm = validate_algorithm(base_algorithm, validation_data)
# Test the final algorithm with an external dataset
external_data = load_external_data( )
# Apply supervised learning tasks
classification_results = deep_forest_classification(final_algorithm,
external_data)
regression_results =
deep_forest_regression(final_algorithm, external_data)
# Apply unsupervised learning task
hidden_patterns =
unsupervised_analysis(final_algorithm, external_data)
# Apply dimensionality reduction
reduced_data =
dimensionality_reduction(final_algorithm, external_data)
# Generate suggested portfolios
suggested_portfolios =
generate_portfolios(final_algorithm, reduced_data)
# Return the suggested portfolios
return suggested_portfolios

It is herein acknowledged that implementation of the method involves defining the functions used here (load_investor_data, load_asset_data, prepare_training_data, train_ml_model, load_validation_data, validate_algorithm, load_external_data, deep_forest_classification, deep_forest_regression, unsupervised_analysis, dimensionality_reduction, generate_portfolios), and could vary significantly depending on the specifics of the databases, the machine learning module, the Deep Forest framework, and other factors.

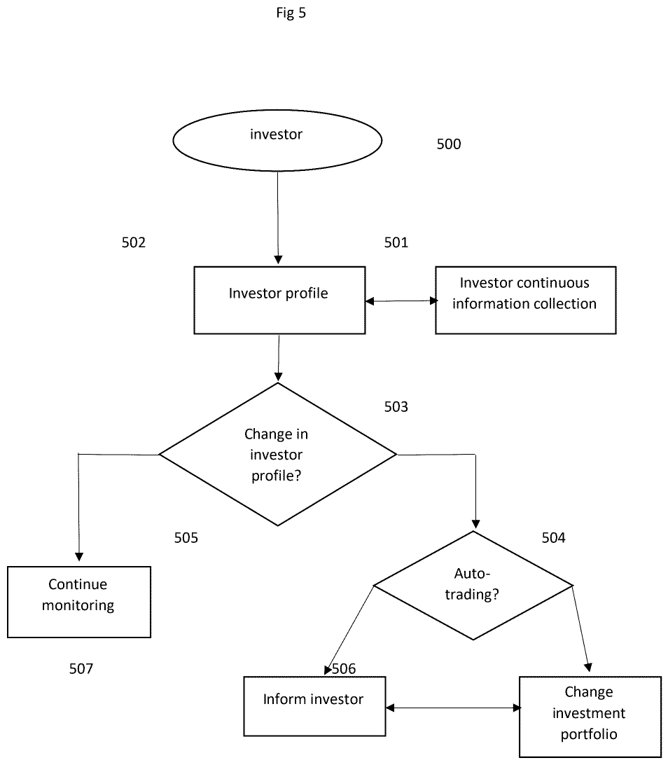

FIG. 5 shows the system's flow the system's interaction with an investor over investor profile changes. The investor (500) has investor profile saved in the system (501), said investor profile is continuously updated based on information gathered from multiple sources (502) (e.g. investment website entrance frequency, phone fall frequency, etc.). The system will occasionally check to see if the investor profile has changed (503), if it did not, the system will continue monitoring the behavior of the investor (504). If the investor profile has changed, the system checks if the investor has decided to allow it to do automatic trading (505). If automatic trading is off—the system will alert the investor in a manner that will not cause unwanted irrational reaction to a recommended change in his investment portfolio (506), with the investor confirmation, the system will change the asset types of the investments (507). In the case of automatic trading, the system will automatically change the investment portfolio (507) and inform the investor after the change (506).

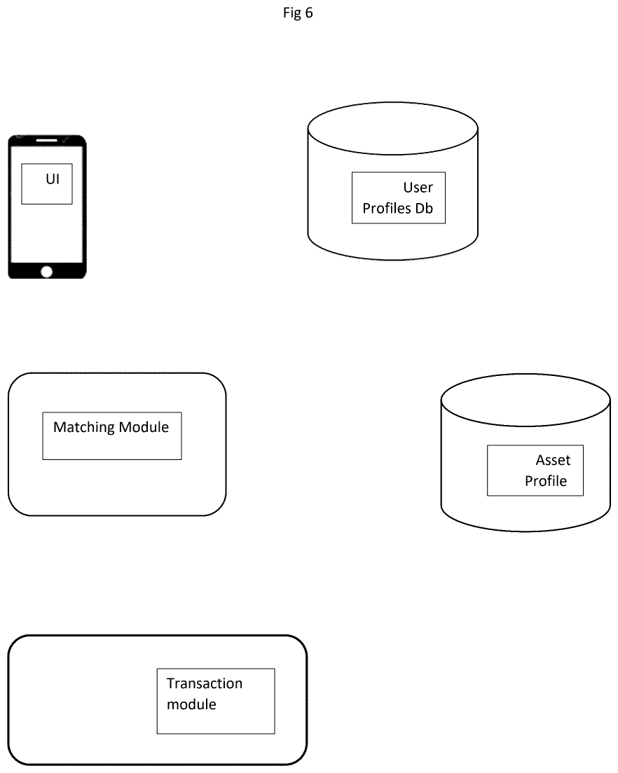

FIG. 6 shows a high level view of modules of the system; the device UI; User Profiles Database, Asset Profile, Matching Module, Transaction Module.

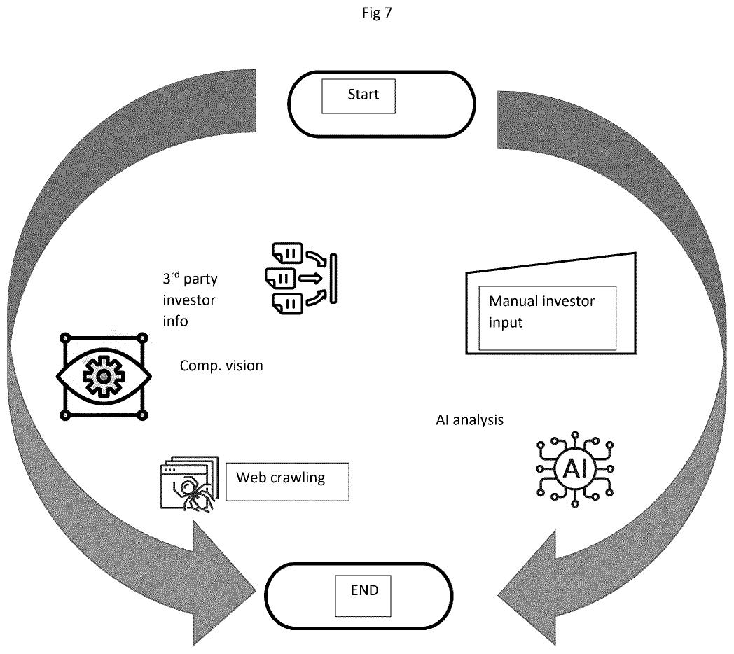

FIG. 7 shows that, in a possible embodiment of the system an investor profile may be built using AI and machine learning, Inputs to the AI system can be any or all of the following:
(i) Manual input by the investor of their information, in the form of questionnaire or interviews
(ii) 3^{rd} party information on the investor
(iii) Computer vision and/or voice analysis
(iv) Web crawling to pick up information on the investor

The information is then processed by AI to build an investor profile.

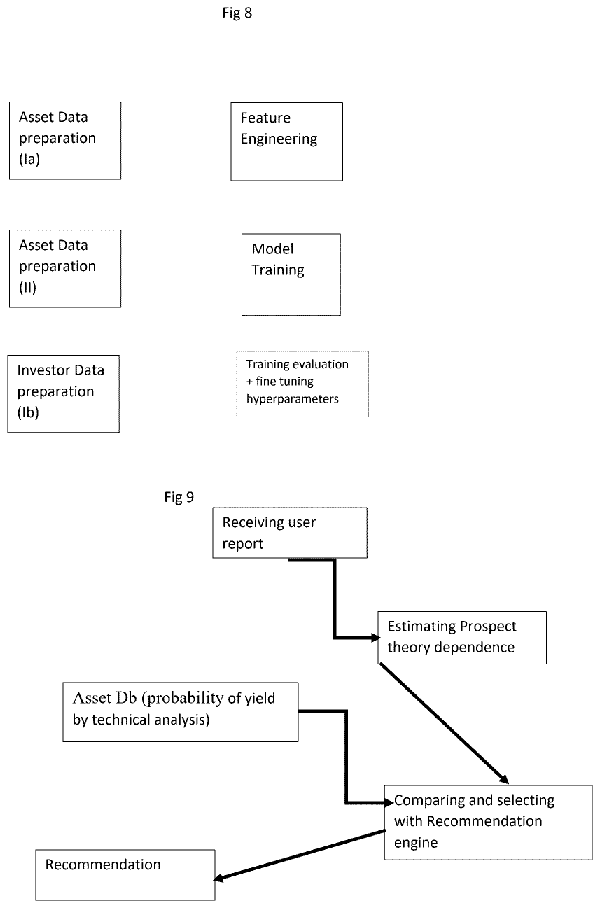

FIG. 8 depicts modules of asset data preparation, Investor data preparation, Feature engineering, Model Training and Training evaluation and fine tuning hyperparameters.

### EXAMPLES

An investor wishes to invest some of his money in a fund. The system analyzes the personality of the investor based on questionnaire as well as through other mediums. Such mediums can be further financial records (to see how much free money the investor has), age, hobbies, social connections, job status and more—this helps the system determine through a machine learning process the volatility and risk aversion scores of the investor. Based on this score the system can apply a specific investment set for that investor-one that will minimize his volatility in constantly changing his investment plan based on emotional reactions.

In another example, for the same investor, the system is continuously receiving new information regarding his status. For example, a change in age, employment status, free income, phone call frequency or website access frequency for checking his investments-all of these may be signs of stress, volatility, and the basis for irrational decisions. The system can then do one of two things-either automatically change the investment portfolio of said investor to a less volatile and less risk path—or it can inform the investor about the proposed changes in a way that will reduce or remove his emotional responses for the changes.

Matching potential investors with financial assets can be approached as a recommendation problem in machine learning (ML). Several models can be used for this task, depending on the nature of the data and specific requirements.

### ML Models

### Collaborative Filtering

This method recommends items based on the preferences of similar users: Recommend financial assets to an investor based on the preferences of similar investors.

### Implementation:

collaborative filtering using techniques like Matrix Factorization, Singular Value Decomposition (SVD), or more advanced methods like Alternating Least Squares (ALS).

### Content Based Filtering:

This method recommends items similar to those the user has liked or interacted with in the past. For financial assets, this could involve analyzing features such as asset type, industry sector, risk level, historical performance, etc.

### Implementation:

Algorithms like cosine similarity or TF-IDF to measure similarity between assets and recommend those with high similarity scores.

### Combinations

These combine collaborative and content-based filtering techniques to provide more accurate recommendations. Collaborative filtering to identify similar investors content-based filtering to recommend assets based on their preferences.

### Deep Learning Models

Neural networks, especially variants like Recurrent Neural Networks (RNNs) or Long Short-Term Memory (LSTM) networks, can be used for recommendation tasks. Train these models on sequences of investor interactions with assets over time to predict future interactions or preferences.

### Factorization Machines

Generalization of matrix factorization for capture of interactions between user and item features in addition to latent factors. Useful when you have rich feature information for both investors and assets.

To implement these models, general steps are followed

### Preparation of Dataset

Prepare dataset, including information about investors (e.g., demographic data, past investment history) and financial assets (e.g., features such as asset type, sector, historical performance

### Feature Engineering

Relevant features are extracted from the dataset. For example, investor age, investment portfolio diversity, or asset volatility, state of mind of the investor,

### Model Training

A chosen model is trained on historical data using gradient descent or alternating least squares. Depending on the complexity of the model, libraries such as TensorFlow, PyTorch, or scikit-learn are used.

### Model Evaluation

The performance of the chosen model is evaluated according to precision, recall, or mean average precision.

The datasets are split into training and testing sets to assess how well the model generalizes to new data.

### Hyperparameter Tuning:

Fine-tune ML model's hyperparameters to optimize its performance. Techniques like grid search or random search are used to find best hyperparameter values

Deployment: The application is deployed to provide real-time recommendations to investors.

Continuously monitor and update model as new data becomes available to ensure that it stays accurate and relevant over time.

Incorporate feedback mechanisms to collect data on investor interactions with recommended assets and improve the model's performance further.

Reference is now made to the following aspects, methods and embodiments of the present invention: A system for recommending investments to an investor is provided. The system comprises one or more memory devices; and one or more processing devices. The system may be implemented in a cloud based asset management system.

The processing devices are operatively coupled to the memory devices. These processing devices are configured to create an asset database from which personalized investment portfolios can be continuously constructed. The asset database is prepared by
(i) inputting predefined financial asset information or data into an electronic database controlled by a database management system (DBMS)
(ii) preprocessing the financial assets by analyzing said asset with analyzing tools. The analyzing tools may be selected from the group consisting of SHARPE, SKEW, Implied Volatility, CALMAR. OMEGA, SORTINO RATIO TREYNOR RATIO, VIX
   A second step of Asset Data preparation is carried out by the following steps:
(iii) defining a first tag and annotation of each asset with asset analysis data obtained from same
(iv) further combining said first tag and first annotated analysis results from a plurality of analyzing means. This is done to define a second tagged and annotated definition of the aforementioned same financial asset
(v) updating the database periodically or continuously to provide sets of tagged and annotated financial assets and steps of investor data preparation Reference is now made to the Investor Data preparation. This stage has steps of creating an investor profile database comprising multiple sourced investor data and information from the group consisting of direct, indirect, implicit and explicit sources. The investor data and information is sent through an Extract Transform Load layer for combining said investor data and information and/or from multiple sources into an Investor Information database. The processing devices are further configured for updating (continuously or periodically) the investor data. The investor data may comprise circumstantial investor information concerning any of the following: Personal information, age, health status, dependents, personality traits, work history, credit score, hobbies, socio-economic status, financial history. The data may further comprise receiving behavioral investor information concerning the investor, phone call frequency, social media participation, FOMO score, financial website accessing frequency, evidence of alteration in emotional status. The system may use AI for interpreting potential for this information to influence the risk aversion score and defined target rate of return score of the investor.

The system then recommends appropriate assets and investments to the investors by an ML training model with defined hyper-parameters.

Reference is now made to an ML training model selected from the group consisting of Collaborative Filtering, Content-Based Filtering, Hybrid Models, Recurrent Neural Networks (RNNs) or Long Short-Term Memory (LSTM), Factorization Machines.

Reference is further made to model training by gradient descent or alternating least squares, sourcing libraries.

The ML model may be evaluated by steps of splitting datasets into training and testing datasets, running the ML model, recording performance metrics comprising precision, recall, or mean average precision and assessing model with new data, fine tuning hyperparameters by random search or grid search to optimize performance.

Reference is now made to an automated computer implemented method for providing an asset database from which personalized investment portfolios can be continuously constructed comprising steps of
(vi) inputting predefined financial asset information or data into an electronic database controlled by a database management system (DBMS)
(vii) preprocessing the financial assets by analyzing the asset with analyzing tools
(viii) defining a first tag and annotation of each asset with asset analysis data obtained from same
(ix) further combining said first tag and first annotated analysis results from a plurality of the analyzing means to define a second tagged and annotated definition of the same financial asset
(x) updating said database periodically or continuously to provide sets of tagged and annotated financial assets.
Reference is now made to a method of the present invention wherein the analyzing tools are selected from the group consisting of SHARPE, SKEW, Implied Volatility, CALMAR, OMEGA, SORTINO RATIO. TREYNOR RATIO.

It is herein disclosed an automated computer implemented method of the invention for inferring or predicting investor preference within a plurality of financial assets. The method comprises steps of
(i) collecting multiple sourced investor data from the group consisting of direct, indirect, implicit and explicit sources
(ii) sending said investor data through an Extract Transform Load layer for combining said investor data from multiple sources into an Investor Information database.
The aforementioned method is acknowledged wherein the investor data comprises any personal information, age, health status, dependents, personality traits, work history, credit score, hobbies, socio economic status, financial history.

The aforementioned method comprises updating continuously or periodically said investor data.

The aforementioned method may also comprise steps of receiving circumstantial investor information concerning said any personal information, age, health status, dependents, personality traits, work history, credit score, hobbies, socio-economic status, financial history and interpreting potential for said information to influence the risk aversion score of said investor.

The aforementioned method is acknowledged as comprising steps of receiving behavioural investor information concerning the investor. Such information may comprise phone call frequency, social media participation, FOMO score, financial website accessing frequency, evidence of alteration in emotional status and interpreting potential for said information to influence the risk aversion score of said investor.

FIG. 9 references the disclosure of a decision support method comprising:
Receiving, by a processor, a report indicating a user-reported investor decision to acquire an asset including user's expected probability of a defined outcome threshold
Estimating, by a processor said user's extent of implementation of prospect theory to said user's expected probability of a defined outcome threshold
Calculating expected probability of a defined outcome threshold of a series of Assets within an Asset Db by the method of Asset Data preparation comprising
   (i) inputting predefined financial asset information or data into an electronic database controlled by a database management system (DBMS)
   (ii) preprocessing said financial assets by analyzing said asset with analyzing tools said analyzing tools selected from the group consisting of SHARPE, SKEW, Implied Volatility, CALMAR, OMEGA, SORTINO RATIO TREYNOR RATIO, VIX
      a second step of Asset Data preparation comprising
      defining a first tag and annotation of each asset with asset analysis data obtained from same
      further combining said first tag and first annotated analysis results from a plurality of said analyzing means to define a second tagged and annotated definition of said same financial asset
         calculating expected probability of a defined outcome threshold of said assets
         comparing probability of said defined outcome with user's expected probability of a defined outcome threshold and recommending to said user any asset or assets with a higher probability of a defined outcome wherein said outcome is equal to or higher than said user's expected probability of said defined outcome threshold.
   The aforementioned method is disclosed wherein the recommendation is based on selecting assets from an asset Db containing assets with different probabilities of gaining a predetermined yield within a predefined time and probabilities of losses within a predefined time.

Reference is now made to FIG. 9 showing steps of the method of the present invention: (i) Receiving the user report containing the user investment decision (ii) estimating the prospect theory dependence of the user decision (iii) inspecting the Asset Db for probability of yield (by technical analysis), comparing and selecting the best asset using the Recommendation engine. It is herein acknowledged that Value at Risk (VaR) assessment is implemented as part of the inspection of the Asset Db to asses risks and set the risk tolerance for given assets or a group of assets. By using VaR potential losses may be quantified over specific time horizons. The minimum loss is calculated with a certain confidence level.

Preceding the recommendation step Monte Carlo simulation and analysis may be implemented using random sampling to create simulated outcomes of assets and investor behaviour. A calculation is made from an equation derived from the methods of FIG. 3 to provide results of how inputs (variables) affect outcomes (e.g., investment returns) Probability distributions for each input (e.g., stock market volatility) are randomly sampled for input values and calculate corresponding outcomes. This is repeated many times to create a distribution of possible results revealing a range of possible outcomes, so that the recommendation is not based on a single prediction.

The various embodiments disclosed above are provided useful to disclose a method and system, to mitigate the consequences of irrational prospect theory investing. This is done by providing a buffered decision support system driven by a recommendation engine which recommends to the user investable assets valued by technical analysis of the asset based on expected utility to the user of the asset.

1.-13. (canceled)

14. A computer implemented investment recommendation system comprising:
a) a specialized database management system configured with distributed processing nodes and real time synchronization protocols for managing financial asset data across multiple data sources;
b) a multi threaded preprocessing engine that concurrently executes a plurality of financial analysis algorithms including Sharpe ratio calculations, volatility assessments and risk scoring computations on financial asset data to generate composite technical indicators that are not performable in the human mind;
c) a behavioural data integration module configured to receive and process investor behavioral data from multiple digital sources including social media activity metrics, website interaction patterns, and transaction frequency data trough automated data pipelines with conflict resolution protocols
d) a machine learning recommendation engine implementing a specific ensemble model architecture combining collaborative filtering and neural network components wherein the ensemble model is trained to generates real time investment recommendations by processing the composite technical indicators and behavioral data; and
e) an automated portfolio execution system configured to automatically implement recommended asset allocations through direct API connections to trading platforms wherein the system reduces emotional decision making latency compared to conventional manual investment processes.

15. The system of claim 14, wherein the machine learning recommendation engine implements a real-time risk adjustment protocol that automatically modifies portfolio recommendations based on detected changes in market volatility within predefined threshold ranges, thereby providing improved computational performance in dynamic market conditions.

16. A method for reducing cognitive bias in investment decisions through automated technical analysis comprising:
a. configuring a distributed computing system with specialized data structures for processing multiple concurrent financial data streams;
b. automatically collecting and preprocessing financial asset data using a multi-algorithm analysis engine that generates asset compatibility scores not determinable through manual analysis;
c. detecting investor behavioral patterns indicative of emotional decision-making through automated analysis of digital interaction data;
d. generating risk-adjusted investment recommendations using a trained machine learning model that counteracts identified behavioral biases by weighing technical analysis results against detected emotional indicators; and
e. automatically executing portfolio adjustments through programmatic trading interfaces to minimize the time delay between recommendation generation and implementation, thereby improving investment outcome consistency compared to manual execution.

17. A computer-implemented method for creating an optimized financial asset database system comprising:
a. configuring a distributed database management system (DBMS) with specialized data structures for real-time financial asset processing;
b. implementing a multi-threaded preprocessing engine that simultaneously executes multiple financial analysis algorithms on asset data;
c. generating composite asset signatures by algorithmically combining analysis results from multiple technical indicators to create unique asset fingerprints;
d. establishing automated database synchronization protocols for continuous asset data updates with conflict resolution mechanisms;
e. wherein the system provides enhanced computational performance for financial data processing compared to conventional database systems.
